(19) United States
(12) Patent Application Publication
(10) Pub. No.: US 2015/0267866 A1
(43) Pub. Date: Sep. 24, 2015

(54) CRYOGENIC FLUID STORAGE TANK AND TRUCK COMPRISING SUCH A TANK

(71) Applicant: CRYOLOR, Ennery (FR)

(72) Inventor: Lucien VARRASSI, Porcelette (FR)

(21) Appl. No.: 14/664,008

(22) Filed: Mar. 20, 2015

(30) Foreign Application Priority Data
Mar. 20, 2014 (FR) 1452324

(51) Int. Cl. F17C 13/00; F17C 1/02; F17C 1/12; B60P 3/22

(52) U.S. Cl. CPC F17C 13/001; B60P 3/2205; F17C 1/02; F17C 1/12; F17C 2203/012; F17C 2203/03; F17C 2203/0624; F17C 2203/0643; F17C 2203/0646; F17C 2205/018

(57) ABSTRACT

Cryogenic fluid storage tank devoid of vacuum insulation and comprising a wall (3) comprising a multilayer structure comprising, from the inside of the tank (1) to the outside of the tank (1):
a leaktight first layer (13) comprising one from among a resin reinforced by glass fibers and/or carbon fibers, a polymer such as polyurethane, aluminum, steel, stainless steel,
a second layer (23) comprising a thickness of laminated material based on carbon fibers and/or glass fibers,
a third layer (33) comprising a thickness of thermal insulation,
a fourth layer (43) comprising a thickness of laminated material based on carbon fibers and/or glass fibers,
   the first layer (13) having a thickness of between 0.1 mm and 6 mm, the second layer (23) having a thickness of between 5 and 40 mm, the third layer (33) having a thickness of between 20 and 200 mm and the fourth layer (43) having a thickness of between 2 and 20 mm.

### CROSS REFERENCE TO RELATED APPLICATIONS

This application claims the benefit of priority under 35 U.S.C. §119 (a) and (b) to French Patent Application No. 1452324 filed Mar. 20, 2014, the entire contents of which are incorporated herein by reference.

### BACKGROUND

The present invention relates to a storage tank for transporting cryogenic fluid.

### SUMMARY

The invention relates more particularly to a storage tank for transporting a cryogenic fluid, in particular liquefied carbon dioxide, the tank being devoid of vacuum insulation and comprising a wall that defines a storage volume for fluid, said wall comprises a multilayer structure.

The transport of large amounts of fluid such as carbon dioxide generally uses vehicles of semi-trailer type comprising a single-walled cryogenic tank (i.e. without a double wall and a vacuum in the inter-wall).

The tank is thermally insulated and stores the fluid at a pressure for example of between 18 bar and 25 bar and a temperature of between −10° C. and −100° C.

For reasons of chemical compatibility, mechanical strength and cold resistance, the storage tank conventionally consists of fine-grained carbon steel, resilient (resistant) at a temperature of −50° C. and provided with external insulation.

The thickness of the steel wall of such a tank is generally around 10 mm for a total mass of the vehicle of 8 to 10 tonnes.

The insulation is generally provided via an insulating layer made of polyurethane having a thickness of 150 mm.

However, such a tank is expensive and has a relatively large mass. Other known structures have other technical problems: incompatibility with a cryogenic liquid, insufficient leak tightness and insufficient mechanical strength, insufficient thermal insulation, etc.

One objective of the present invention is to overcome all or some of the drawbacks of the prior art raised above.

For this purpose, the tank according to the invention, furthermore in accordance with the generic definition that the preamble above gives thereof, is essentially characterized in that the multilayer structure of the wall comprises, from the inside of the tank to the outside of the tank:
a leaktight first layer comprising one from among: a resin reinforced by glass fibers and/or carbon fibers, a polymer such as polyurethane, aluminum, steel, stainless steel,
a second layer comprising a thickness of laminated material based on carbon fibers and/or glass fibers,
a third layer comprising a thickness of thermal insulation,
a fourth layer comprising a thickness of laminated material based on carbon fibers and/or glass fibers,
   the first layer having a thickness of between 0.1 mm and 6 mm, the second layer having a thickness of between 5 and 40 mm, the third layer having a thickness of between 20 and 200 mm and the fourth layer having a thickness of between 2 and 20 mm.

Preferably, the wall comprises a multilayer structure, said multilayer structure consisting of said four layers stacked one on top of the other in this order from the inside to the outside of the tank.

Furthermore, embodiments of the invention may comprise one or more of the following features:
at least one from among: the second layer and the fourth layer comprises carbon fibers or glass fibers that are laminated by means of an epoxy or polyamide resin;
the third layer comprises at least one from among: expanded polystyrene, extruded polystyrene, polyurethane, mineral wool, animal wool, wood fibers, hemp fibers, natural cotton fiber, flax, sheep's wool, duck feathers, cellulose wadding, expanded cork, perlite, expanded vermiculite, cellular glass, at least one vacuum insulation panel, the at least one panel consisting of an aerogel wrapped in a leaktight film placed under vacuum, the aerogel possibly being of “nanostructured silica” type, a polyurethane foam in particular an insulating foam of polyurethane type, balsa wood and a layer comprising a sandwich core;
the first layer has a thickness of between 0.5 mm and 5 mm, the second layer has a thickness of between 10 and 30 mm, the third layer has a thickness of between 40 and 150 mm and the fourth layer has a thickness of between 4 and 15 mm;
the first layer has a thickness of between 1 and 4 mm, the second layer has a thickness of between 15 and 25 mm, the third layer has a thickness of between 40 and 150 mm and the fourth layer has a thickness of between 4 and 15 mm;
the tank has a cylindrical general shape and comprises a plurality of support legs which extend over a portion of the circumference of the tank in order to form elements for holding and fixing the tank in a horizontal position;
the support legs are positioned around the outer wall and a filament winding is carried out around the outer wall provided with the support legs;
the tank comprises, in the internal volume defined by the inner wall, at least one partition transverse to a longitudinal axis of the tank, the at least one partition being perforated in order both to allow a surge of liquid in the tank along a direction parallel to the longitudinal axis and to form a surge plate;
the at least one transverse partition consists of the same material as the first layer;
the at least one transverse partition is fastened to a tubular section forming a central portion of the wall of the tank;
the at least one transverse partition is mounted clamped between two tubular sections assembled to one another in order to form a central portion of the wall of the tank;
the two ends of the central portion of the tank are sealed by end walls fastened to the ends of the central portion of the wall (3) of the tank;
the wall comprises at least one mechanical reinforcing element positioned on its outer surface at the location of the at least one transverse partition;
a reinforcing fiber winding is wound around the central portion and the end walls assembled to the two ends of the central portion.

The invention also relates to a semi-trailer comprising a tank according to any one of the features hereinabove or hereinbelow.

The invention may also relate to any alternative process or device comprising any combination of the features hereinabove or hereinbelow.

### BRIEF DESCRIPTION OF THE DRAWINGS

It will be understood that many additional changes in the details, materials, steps and arrangement of parts, which have been herein described in order to explain the nature of the invention, may be made by those skilled in the art within the principle and scope of the invention as expressed in the appended claims.

Thus, the present invention is not intended to be limited to the specific embodiments in the examples given above.

Other distinctive features and advantages will appear on reading the description below, given with reference to the figures in which:

FIG. 1 represents a schematic and partial side view illustrating a mobile tank on a semi-trailer vehicle;

FIG. 2 represents a side view, in schematic and partial vertical cross section, illustrating an example of the structure of the wall for one embodiment of the tank according to the invention;

FIG. 3 represents a schematic and partial transverse cross-sectional view illustrating an example of the structure of the tank for one possible embodiment according to the invention;

FIG. 4 represents a schematic and partial perspective view illustrating an example of the structure of the tank according to one possible embodiment of the invention;

FIGS. 5 and 6 illustrate exploded side and cross-sectional views respectively illustrating two possible examples of structures of the tank according to the invention.

### DESCRIPTION OF PREFERRED EMBODIMENTS

The invention relates to a storage tank for transporting cryogenic fluid and more specifically to a tank capable of storing CO₂ in the form of a mixture of liquid and gas at low temperatures, for example of between −10° C. and −100° C., and at a pressure of between 18 bar and 25 bar.

As illustrated in FIG. 1, and without this being limiting, such a tank 1 (or tank body) may be mounted in a detachable or fixed manner onto the trailer of a vehicle 2 such as a lorry.

According to the invention, the structure of the tank is modified with respect to the prior art by the use of a particular composite structure.

Liquefied CO₂ does not pose a problem of chemical compatibility with the materials described hereinabove or hereinbelow.

That is to say that, instead of a conventionally used fine-grained carbon steel partition, it is possible to use a tank comprising a gelcoat inner surface. For example, a resin thickness of the order of 1 mm may be provided to which a first skin (conventional composite construction) is laminated. This makes it possible to obtain a smooth surface and to provide the pressurized liquid with a minimum leak tightness.

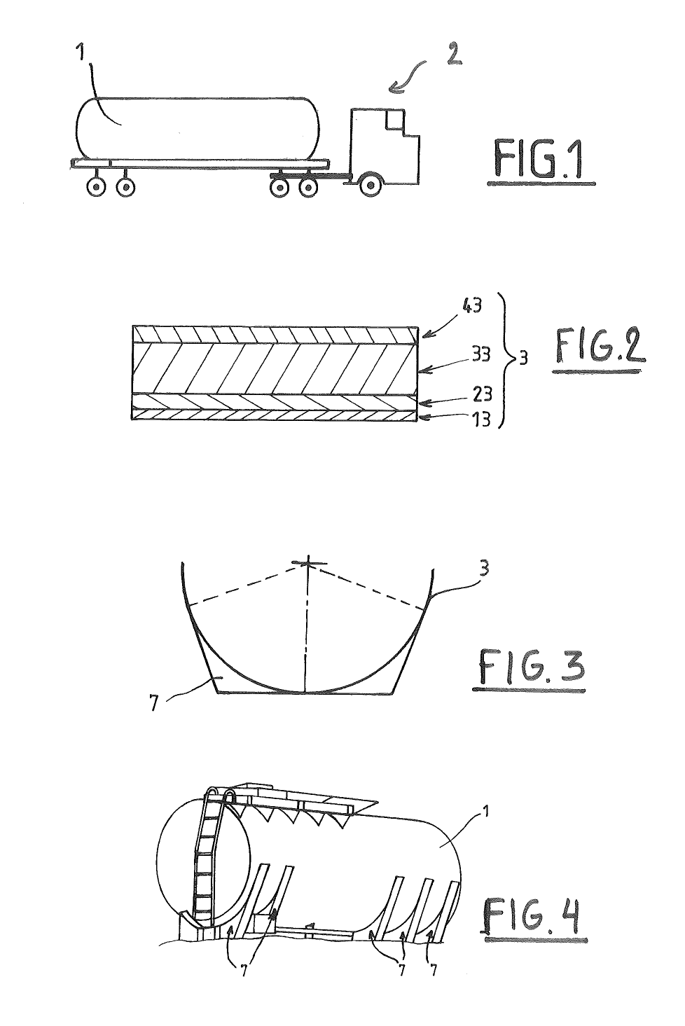

As illustrated in FIG. 2, the wall 3 of the tank 1 preferably comprises a multilayer structure comprising, from the inside of the tank to the outside of the tank:
a leaktight metallic first layer 13 in particular consisting of aluminum, steel or stainless steel,
a second layer 23 comprising a thickness of laminated material based on carbon fibers and/or glass fibers,
a third layer 33 comprising a thickness of thermal insulation,
a fourth layer 43 comprising a thickness of laminated material based on carbon fibers and/or glass fibers.

For example, one from among: the second layer 23 and the fourth layer 43 comprises carbon fibers or glass fibers that are laminated by means of an epoxy or polyamide resin.

The third layer 33 forms thermal insulation and preferably comprises at least one from among: expanded polystyrene (EPS), extruded polystyrene (XPS), polyurethane (PUR), mineral wool, animal wool, wood fibers, hemp fibers, natural cotton fiber, flax, sheep's wool, duck feathers, cellulose wadding, expanded cork, perlite, expanded vermiculite, cellular glass, at least one vacuum insulation panel, the at least one panel consisting of an aerogel wrapped in a leaktight film placed under vacuum, the aerogel possibly being of “nanostructured silica” type, a polyurethane foam in particular an insulating foam of polyurethane type, balsa wood and a layer comprising a sandwich core.

The first layer 13 preferably has a thickness of between 0.1 mm and 6 mm, and more preferably between 0.5 mm and 5 mm, for example 1 mm or 4 mm, or between 1 and 3 mm, for example 1 mm or 3 mm.

The second layer 23 has a thickness preferably of between 5 and 60 mm or between 5 and 40 mm and more preferably between 10 and 30 mm, for example between 15 and 25 mm, and in particular 20 mm.

The third layer 33 has, for example, a thickness of between 20 and 300 mm, preferably between 20 and 200 mm, for example 20 mm or between 40 and 150 mm.

The fourth layer 43 preferably has a thickness of between 2 and 30 mm and more preferably of between 4 and 20 mm, for example 20 mm or between 4 and 15 mm.

This composite structure of the wall 3 constituting the tank 1 permits satisfactory thermal insulation, good leak tightness of everything while guaranteeing a good mechanical strength of the whole assembly. This structure has a good chemical compatibility with CO₂ and a relatively low mass.

This modular structure makes it possible to impart to the whole assembly a given stiffness and a resistance to buckling and to dynamic forces.

Preferably, the internal volume defined by the walls 3 comprises transverse partitions 8 that are perforated at the centre thereof in order to form surge plates (central openings having a diameter of the order of 100 mm to 800 mm for example).

As illustrated in FIG. 5, this partition 3 may consist of several cylindrical sections 102 assembled in series, the perforated transverse partitions 8 that form surge plates being inserted and fitted between two adjacent cylindrical sections 102.

Once this cylindrical central portion is assembled, it can be wound with reinforcing composite material. After winding, this cylindrical portion may be sealed at its ends by respective ends 202 for example that are pre-molded and also covered with this layer (the ends have the same multilayer structure as the central cylindrical portion, cf. FIG. 6). The ends 202 may be assembled to the central portion via supplementary local winding of this second layer (resin+fibers). This overlapping circumferential additional local winding may be over a longitudinal region having a width of 100 to 200 mm for example.

According to another possible embodiment, the two thermoformed ends 202 are of the same material as the wall 3 of the central portion and the winding is carried out over the whole assembly (central portion+ends 202). This winding may not in principle be carried out up to the axis of the structure (due to the holding tool at the ends). If need be, a finishing via manual lamination may be carried out if necessary after winding as closely as possible to the axis (to a diameter of 300 mm for example).

The tank 1 is preferably reinforced at the portions comprising the transverse partitions 8. For example, reinforcements made of balsa wood may be provided locally around the cylindrical portion in order to locally reinforce the tank 1 in order to withstand the dynamic local stresses that are transmitted to the interface (for example a mass of pressurized liquid against the surge plates under 2 g of forward liquid displacement.

In the case of a first layer 13 made of aluminum or stainless steel or steel, a sub-assembly comprising the partitions 8 made of aluminum (having the required thickness to withstand the dynamic effects of the liquefied gas), the cylindrical central portion (shell) and the ends 202 may be produced by sheet metalwork. This minimum thickness may be welded by known welding processes of TIG or MIG/MAG type provided that suitable holding tools are used.

The whole assembly thus welded may then be covered with other layers 23, 33, 43 and optionally with a filament winding.

The two pre-molded ends 202 may be assembled and welded to the central portion and the whole assembly may be covered with other layers by assembly lamination.

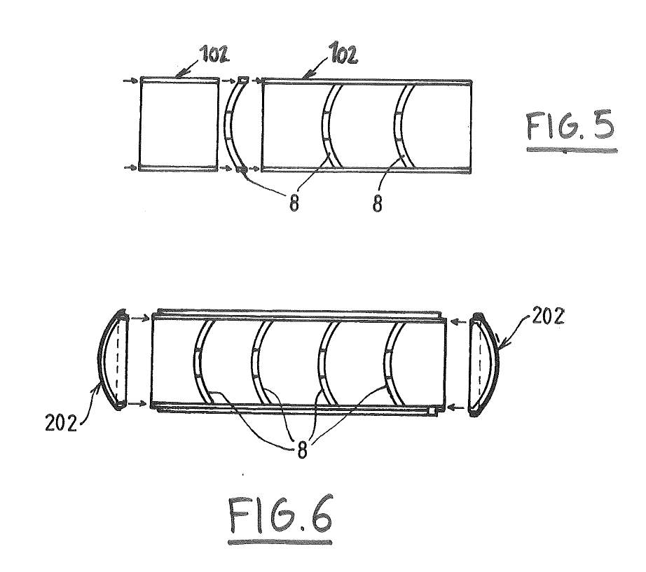

As illustrated in FIGS. 3 and 4, the tank 1 preferably has a cylindrical general shape and comprises a plurality of support legs 7 which extend over a portion of the circumference of the tank 1 in order to form elements for holding and fixing the tank in a horizontal position.

These supports 7 are preferably positioned around the outer wall 3 and a filament winding may be carried out around the outer wall 3 equipped with the support legs 7. These supports 7 also form structural reinforcements.

While being suitable (chemically, mechanically and thermally) for transporting carbon dioxide, such a tank structure makes it possible to significantly reduce the mass and the cost of the tank with respect to the prior art.

Thus, for a semi-trailer tank body having a volume of around 26,000 liters, the mass of the tank may be approximated in the following manner:
a first layer 13 (liner) made of polyurethane of around 200 kg (around 1100 kg in the case of stainless steel or around 400 kg in the case of aluminum),
a second layer having a thickness of 20 mm made of laminated material (carbon+resin) over a surface area of 70 m² increased by 10% at the local reinforcements (end of the shell, thicker base than the rest, etc.) may be estimated at 2300 kg,
an insulating third layer having a thickness of between 40 and 150 mm of balsa wood in order to reinforce the structure at the cradles can be estimated at 700 kg,
a fourth layer having a thickness of 4 mm made of laminated material (carbon+resin) having a mass of around 500 kg,
four surge plate walls 8 having a total mass estimated at 200 kg in total,
seven cradles and assembly windings evaluated at 200 kg in total.

The total mass of the tank according to one embodiment of the invention may thus be estimated at 4100 kg approximately.

The mass of the tanks according to the prior art having a fine-grained carbon steel structure is around 8000 kg. Thus, the weight saving with respect to the carbon steel may be of the order of 3900 kg.

Besides this considerable weight saving, the solution according to the invention is also more advantageous as regards its cost (saving made by the reduction of the mass of steel used).

The first layer preferably consists of aluminum, stainless steel or fine-grained carbon steel that is resilient at a temperature of −50° C.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A storage tank for transporting a cryogenic fluid, in particular liquefied carbon dioxide, the tank being devoid of vacuum insulation and comprising a wall that defines a storage volume for fluid, said wall comprises a multilayer structure, characterized in that the multilayer structure of the wall comprises, from the inside of the tank to the outside of the tank:
a leaktight metallic first layer in particular comprising one from among aluminum, steel, stainless steel,
a second layer comprising a thickness of laminated material based on carbon fibers and/or glass fibers,
a third layer comprising a thickness of thermal insulation,
a fourth layer comprising a thickness of laminated material based on carbon fibers and/or glass fibers, the first layer having a thickness of between 0.1 mm and 6 mm, the second layer having a thickness of between 5 and 40 mm, the third layer having a thickness of between 20 and 200 mm and the fourth layer having a thickness of between 2 and 20 mm.

2. The tank of claim 1, wherein at least one from among the second layer and the fourth layer comprises carbon fibers or glass fibers that are laminated by means of an epoxy or polyamide resin.

3. The tank of claim 1, wherein the third layer comprises at least one from among expanded polystyrene (EPS), extruded polystyrene (XPS), polyurethane (PUR), mineral wool, animal wool, wood fibers, hemp fibers, natural cotton fiber, flax, sheep's wool, duck feathers, cellulose wadding, expanded cork, perlite, expanded vermiculite, cellular glass, at least one vacuum insulation panel, the at least one panel consisting of an aerogel wrapped in a leaktight film placed under vacuum.

4. The tank of claim 1, wherein the first layer has a thickness of between 0.5 mm and 5 mm, the second layer has a thickness of between 10 and 30 mm, the third layer has a thickness of between 40 and 150 mm and the fourth layer has a thickness of between 4 and 15 mm.

5. The tank of claim 1, wherein the first layer has a thickness of between 1 and 4 mm, the second layer has a thickness of between 15 and 25 mm, the third layer has a thickness of between 40 and 150 mm and the fourth layer has a thickness of between 4 and 15 mm.

6. The tank of claim 1, wherein the tank has a cylindrical general shape and comprises a plurality of support legs which extend over a portion of the circumference of the tank in order to form elements for holding and fixing the tank in a horizontal position.

7. The tank of claim 6, wherein the support legs are positioned around the outer wall and in that a filament winding is carried out around the outer wall provided with the support legs.

8. The tank of claim 1, further comprising, in the internal volume defined by the inner wall, at least one partition transverse to a longitudinal axis of the tank, the at least one partition being perforated in order both to allow a surge of liquid in the tank along a direction parallel to the longitudinal axis and to form a surge plate.

9. The tank of claim 8, wherein the at least one transverse partition consists of the same material as the first layer.

10. The tank of claim 8, wherein the at least one transverse partition is fastened to a tubular section forming a central portion of the wall of the tank.

11. The tank of claim 8, wherein the at least one transverse partition is mounted clamped between two tubular sections assembled to one another in order to form a central portion of the wall of the tank.

12. The tank of claim 10, wherein the two ends of the central portion of the tank are sealed by end walls fastened to the ends of the central portion of the wall of the tank.

13. The tank of claim 8, wherein the wall comprises at least one mechanical reinforcing element positioned on its outer surface at the location of the at least one transverse partition.

14. The tank of claim 12, wherein a reinforcing fiber winding is wound around the central portion and the end walls assembled to the two ends of the central portion.

15. A semi-trailer comprising a tank of claim 1.
